(19) United States
(12) Patent Application Publication
(10) Pub. No.: US 2025/0034040 A1
(43) Pub. Date: Jan. 30, 2025

(54) ULTRA-HIGH-TOUGHNESS MULTIFUNCTIONAL SELF-ASSEMBLY C-S-H GEL MATERIAL AND PREPARATION METHOD THEREOF

(71) Applicant: Wuhan University of Technology, Wuhan (CN)

(72) Inventors: Chuanlin Hu, Wuhan (CN); Shun Yao, Wuhan (CN); Zengxing Yan, Wuhan (CN); Fazhou Wang, Wuhan (CN); Shuguang Hu, Wuhan (CN)

(21) Appl. No.: 18/239,965

(22) Filed: Aug. 30, 2023

(30) Foreign Application Priority Data
Jul. 26, 2023 (CN) 2023109378151

(51) Int. Cl. C04B 12/00; C04B 28/00

(52) U.S. Cl. CPC C04B 12/005; C04B 28/005; C04B 2103/0062; C04B 2103/0093

(57) ABSTRACT

The invention discloses an ultra-high-toughness multifunctional self-assembly C-S-H gel material and preparation method thereof. The ultra-high-toughness multifunctional self-assembly C-S-H gel material includes several stacked core-shell structure layers, wherein the core-shell structural layer is composed of several core-shell structure particles; the core-shell structure particles are composed of calcium silicate hydrate nanoparticles as the core and poly(acrylamide-co-acrylic acid) as the shell. The obtained ultra-high-toughness multifunctional self-assembly C-S-H gel material has high toughness, good tensile performance and temperature sensitive effect.

### FIELD OF THE DISCLOSURE

The disclosure relates to an ultra-high-toughness multifunctional self-assembly C-S-H gel material and preparation method thereof, which can be used as building materials.

### BACKGROUND

Functional materials refer to high-tech materials that have excellent electrical, magnetic, optical, thermal, acoustic, mechanical, chemical, and biomedical functions, or special physical, chemical, and biological effects, and that can achieve mutual transformation of functions. They are mainly used to manufacture various functional components and widely used in various high-tech fields. The research focuses on functional ceramics and functional polymers, which have been widely applied in fields such as electronic technology, sensing technology, laser technology, optoelectronic technology, infrared technology, biotechnology, environmental science, etc. However, in the field of construction, cement-based functional materials are still widely used. Due to the late start of research and development on cement-based functional materials, so far, the application of cement-based functional composite materials mainly focuses on cement-based conductive composite materials, cement-based dielectric composite materials, cement-based piezoelectric composite materials, and cement-based electromagnetic shielding composite materials. It results in a relatively single functional application of cement-based materials. Modern architecture poses new challenges to cement-based composite materials, which not only requires high strength, toughness, and durability, but also requires new functions such as light or temperature sensitivity to meet the needs of multifunctional and intelligent buildings.

The calcium silicate hydrate (C-S-H) gel is the main product of cement hydration and the most important cementation phase of cement-based materials. Improving the structure and performance of the calcium silicate hydrate (C-S-H) gel can affect the function of cement-based materials. In related technologies, the most effective way to improve the toughness of C-S-H gel is to introduce flexible substances into the structure of C-S-H gel and build C-S-H/organic hybrid in the nano/micro scale.

However, in previous studies on the toughening of C-S-H gel by organic compounds, most of the organic compounds were directly introduced into the synthesis of C-S-H gel, which made the toughening potential of organic compounds have not been fully utilized, thus leading to its weak toughening effect. In addition, the research on functional modification of C-S-H gel by organic compounds is relatively scarce, so it is necessary to propose a kind of calcium silicate hydrate gel material to improve its toughness and endow it with temperature sensitive effect, so as to adapt to the application of cement-based functional composites.

### SUMMARY

The present invention discloses an ultra-high-toughness multifunctional self-assembly C-S-H gel material and preparation method thereof, wherein the ultra-high-toughness multifunctional self-assembly C-S-H gel material has high toughness, good tensile performance and temperature sensitive effect.

In order to achieve the above technical objectives, the following technical solutions are adopted in this application:

In the first aspect, the present invention provides an ultra-high-toughness multifunctional self-assembly C-S-H gel material, comprising several stacked core-shell structure layers, wherein the core-shell structural layer is composed of several core-shell structure particles; the core-shell structure particles are composed of calcium silicate hydrate nanoparticles as the core and poly(acrylamide-co-acrylic acid) as the shell.

In the second aspect, the invention provides a preparation method of the ultra-high-toughness multifunctional self-assembly C-S-H gel material above,

The advantages of the technical scheme proposed in the disclosure are: including the following steps:
S1, obtaining a calcium silicate hydrate suspension;
S2, mixing and stirring acrylic acid, acrylamide, ionic solvent, photoinitiator and crosslinker, and adding them to the calcium silicate hydrate suspension to obtain a C-S-H-AA-AAM slurry;
S3, irradiating the C-S-H-AA-AAM slurry with ultraviolet light to carry out in-situ polymerization and self-assembly reaction, and obtaining the ultra-high-toughness multifunctional self-assembly C-S-H gel material.

In the third aspect, the ultra-high-toughness multifunctional self-assembly C-S-H gel material above is used for preparing cement-based materials.

The advantages of the present invention are as follows:
1) The present invention utilizes in-situ polymerization of acrylic acid and acrylamide monomers on the C-S-H nanoparticles to construct a unique core-shell structure consisting of a core (C-S-H) and a shell (polymer with cross-linked network structure) cross-linking network; then, through the self-assembly between polymer molecules, a self-assembly C-S-H gel with a highly ordered layered structure was formed.
2) The self-assembly C-S-H gel material produced in the invention has ultra-high toughness and excellent tensile deformation ability, providing a new idea for the toughening design of cement-based materials in the nano/micro scale.
3) The self-assembled C-S-H gel material in the invention has special shape memory function and temperature sensitive effect, providing a very potential application path for the future multifunctional application of cement-based materials.

### BRIEF DESCRIPTION OF THE DRAWINGS

Accompanying drawings are for providing further understanding of embodiments of the disclosure. The drawings form a part of the disclosure and are for illustrating the principle of the embodiments of the disclosure along with the literal description. Apparently, the drawings in the description below are merely some embodiments of the disclosure, a person skilled in the art can obtain other drawings according to these drawings without creative efforts. In the figures:

FIG. 1 shows the transmission electron microscope spectrum images of the material in Example 1 under different lighting times;

FIG. 2 shows the comparison of product shapes with different materials;

FIG. 3 is a process flow diagram of the present invention;

FIG. 4 shows the tensile stress curves of the material in Example 1 at different temperatures.

### DETAILED DESCRIPTION OF PREFERRED EMBODIMENTS

The present invention provides an ultra-high-toughness multifunctional self-assembly C-S-H gel material, comprising several stacked core-shell structure layers, wherein the core-shell structural layer is composed of several core-shell structure particles; the core-shell structure particles are composed of calcium silicate hydrate nanoparticles as the core and poly(acrylamide-co-acrylic acid) as the shell.

The ultra-high-toughness multifunctional self-assembly C-S-H gel material has high toughness, good tensile performance and temperature sensitive effect.

Preferably, the calcium silicate hydrate nanoparticles are needle bar structure.

Preferably, the mass of poly(acrylamide-co-acrylic acid) accounts for 10-30% of the total mass of the ultra-high-toughness multifunctional self-assembly C-S-H gel material.

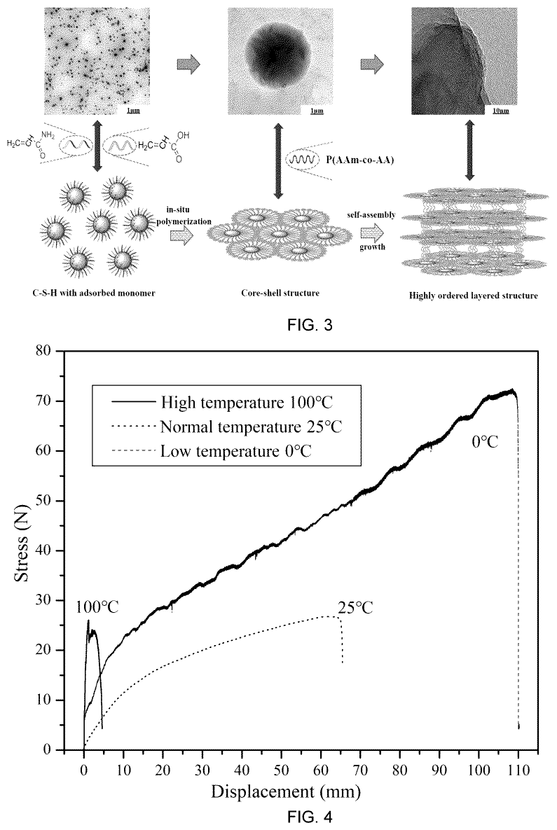

As shown in FIG. 3, the preparation method of the ultra-high-toughness multifunctional self-assembly C-S-H gel material, including the following steps:
S1, obtaining a calcium silicate hydrate suspension;
S2, mixing and stirring acrylic acid, acrylamide, ionic solvent, photoinitiator and crosslinker, and adding them to the calcium silicate hydrate suspension to obtain a C-S-H-AA-AAM slurry;
S3, irradiating the C-S-H-AA-AAM slurry with ultraviolet light to carry out in-situ polymerization and self-assembly reaction, and obtaining the ultra-high-toughness multifunctional self-assembly C-S-H gel material.

The invention uses the in-situ polymerization method to prepare the self-assembly C-S-H gel that can be stretched and deformed. Its core material is C-S-H (calcium silicate hydrate) nanoparticles as the dispersed phase, in which reaction monomers and catalysts are added. Then, by adjusting the polymerization conditions and using photoinitiation, the reaction monomers (acrylic acid, acrylamide) are polymerized on the C-S-H nanoparticles. By in-situ polymerization on C-S-H nanoparticles, a unique core-shell structure C-S-H/organic crosslinked network was constructed. Then, the C-S-H gel with the highly ordered layered structure is formed by the self-assembly of polymer molecules through mutual attraction and aggregation. Meanwhile, the C-S-H nanoparticles are also transformed into needle bar like calcium silicate hydrates nanoparticles that exist in the C-S-H gel materials. The self-assembled C-S-H gel has special shape memory function and temperature sensitive characteristics.

The specific S1 process is as follows: dissolving sodium metasilicate nonahydrate in deionized water to obtain a sodium silicate solution, and dissolving calcium nitrate tetrahydrate in deionized water to obtain a calcium nitrate solution; dropping the calcium nitrate solution into the sodium silicate solution, then stirring to obtain the calcium silicate hydrate suspension. In a specific embodiment, the calcium source in the preparation of C-S-H solution is analytical grade calcium nitrate tetrahydrate, the silicon source is analytical grade sodium metasilicate nonahydrate, and the molar ratio of calcium nitrate tetrahydrate to Sodium metasilicate nonahydrate is 3:2-1.

Preferably, the ionic solvent is 1-ethyl-3-methylimidazolium ethyl sulfate; the ratio of the total masses of acrylic acid and acrylamide to the mass of the ionic solvent is 3.3-4:1. The ionic solvent is used to simultaneously dissolve both enoic acid and acrylamide monomers, facilitating polymerization reactions.

Preferably, the photoinitiator above is 2-hydroxy-4′-(2-hydroxyethoxy)-2-methylpropiophenone; the ratio of the total masses of acrylic acid and acrylamide to the mass of the photoinitiator is 100:0.5-1.the crosslinker is N,N′-methylenebis(acrylamide); the total masses of acrylic acid and acrylamide to the mass of the crosslinker is 100:0.5-1. The photoinitiator of the invention is used to provide free radicals to open the carbon-carbon double bond of acrylic acid, resulting in the formation of carbon cations, which attack one of the double bonds; meanwhile, the crosslinker N,N-methylenebenzene-acrylamide, which can be attacked by carbon cations, is added to form a three-dimensional spatial network structure between the single chains of polymethacrylic acid.

Preferably, the mass ratio of acrylic acid to acrylamide is 1:4-5. The acrylic structural unit mainly makes the self-assembly C-S-H gel have a certain flexibility, while the acrylamide structural unit makes the self-assembly C-S-H gel have a certain rigidity and strength. However, exceeding the limit of the invention may result in more surface cracks or inability to form.

In the third aspect, the ultra-high-toughness multifunctional self-assembly C-S-H gel material above is used for preparing cement-based materials. The application temperature of the cement-based material of the present invention is 0-100° C.

### Example 1

In this example, the ultra-high-toughness multifunctional self-assembly C-S-H gel material, comprising several stacked core-shell structure layers, wherein the core-shell structural layer is composed of several core-shell structure particles; the core-shell structure particles are composed of calcium silicate hydrate nanoparticles as the core and poly(acrylamide-co-acrylic acid) as the shell. The mass of poly(acrylamide-co-acrylic acid) accounts for 15% of the total mass of ultra-high toughness multifunctional self-assembly C-S-H gel material.

This embodiment provides a method of the ultra-high-toughness multifunctional self-assembly C-S-H gel material, including the following steps:
S1, Dissolving 28.4 g of sodium metasilicate nonahydrate in 60 ml of deionized water at 40° C. to obtain a sodium silicate solution; dissolving 35.42 g of calcium nitrate tetrahydrate in 60 ml of deionized water to obtain a calcium nitrate solution; dropping the calcium nitrate solution into the sodium silicate solution and stirring to obtain the calcium silicate hydrate suspension.
S2, Mixing and stirring 2 g acrylic acid, 8 g acrylamide, 3.3 g ionic solvent, 0.05 g photoinitiator, and 0.05 g crosslinker, and adding them to the calcium silicate hydrate suspension in step S1; stirring for 60 min to obtain C-S-H-AA-AAM slurry.
S3, Pouring the C-S-H-AA-AAM slurry into the mold, irradiating the C-S-H-AA-AAM slurry with ultraviolet light to carry out in-situ polymerization and self-assembly reaction, and obtaining the ultra-high-toughness multifunctional self-assembly C-S-H gel material.

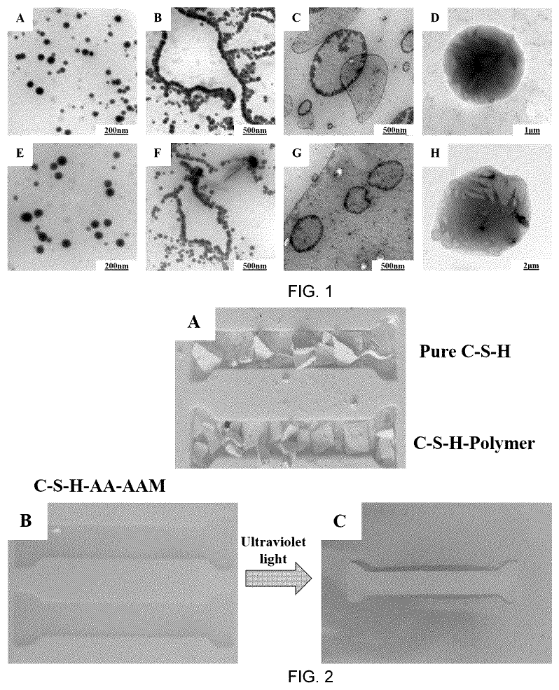

As shown in FIG. 1, they are transmission electron microscopy images under different lighting times. FIG. 1(A) and FIG. 1(E) are the C-S-H morphologies without light, and (A) and (E) are the morphologies of C-S-H gel materials photographed at different locations; the C-S-H morphology (B) and (F) in FIG. 1(B) and FIG. 1(F) correspond to (A) and (E) respectively after 5 minutes of illumination; FIG. 1(C) and FIG. 1(G) show the C-S-H morphology after 10 minutes of illumination. FIG. 1(C) and FIG. 1(G) correspond to (A) and (E), respectively; FIG. 1(D) and FIG. 1(H) show the C-S-H morphology after 15 minutes of illumination, with (D) and (H) corresponding to (A) and (E), respectively. This indicates that within 5-10 min, driven by the polymerization reaction, individual C-S-H nanoparticles are encapsulated one by one by the polymer, and forming a clear spherical particle aggregate, in which a clear core-shell structure appears. Then, after a certain period of illumination, the spherical C-S-H nanoparticles in the spherical particle aggregate gradually grow into needle bar like C-S-H nanoparticles (FIG. 1D, FIG. 1H). Finally, through self-assembly between polymers, C-S-H with core-shell structure is assembled into the C-S-H gel with highly ordered layered structure.

### Example 2

The preparation steps of the ultra-high-toughness multifunctional self-assembly C-S-H gel material in this example are based on Example 1. The difference is that the mass of poly(acrylamide-co-acrylic acid) accounts for 30% of the total mass of ultra-high toughness multifunctional self-assembly C-S-H gel material.

### Example 3

The preparation steps of the ultra-high-toughness multifunctional self-assembly C-S-H gel material in this example are based on Example 2. The difference is the step S2. Mixing and stirring 2 g acrylic acid, 8 g acrylamide, 2.5 g ionic solvent, 0.1 g photoinitiator, and 0.1 g crosslinker, and adding them to the calcium silicate hydrate suspension in step S1; stirring for 60 min to obtain C-S-H-AA-AAM slurry.

### Comparative Example 1

The preparation process of Comparative Example 1 are as follows:

Dissolving 28.4 g of sodium metasilicate nonahydrate in 60 ml of deionized water at 40° C. to obtain a sodium silicate solution; dissolving 35.42 g of calcium nitrate tetrahydrate in 60 ml of deionized water to obtain a calcium nitrate solution; dropping the calcium nitrate solution into the sodium silicate solution and stirring to obtain the calcium silicate hydrate suspension;

Pouring the calcium silicate hydrate suspension into the mold, irradiating it with ultraviolet light to obtain a C-S-H gel material.

### Comparative Example 2

The preparation process of Comparative Example 2 are as follows:

Dissolving 28.4 g of sodium metasilicate nonahydrate in 60 ml of deionized water at 40° C. to obtain a sodium silicate solution; dissolving 35.42 g of calcium nitrate tetrahydrate in 60 ml of deionized water to obtain a calcium nitrate solution; dropping the calcium nitrate solution into the sodium silicate solution and stirring to obtain the calcium silicate hydrate suspension;

Mixing and stirring 10 g poly(acrylamide-co-acrylic acid), 3.3 g ionic solvent, 0.05 g photoinitiator, and 0.05 g crosslinker, and adding them to the calcium silicate hydrate suspension in step S1; stirring for 60 min to obtain the mixture; pouring the mixture into the mold, irradiating it with ultraviolet light to obtain a C-S-H gel material.

### Test and Analysis

As shown in FIG. 2, FIG. 2C and FIG. 2D show the morphologies of the C-S-H gel material obtained by the invention at different angles, indicating that the scheme is feasible; As shown in FIG. 2, A and B respectively deal with the materials obtained from the Comparative Example 1 and comparative example 2. The results show that the C-S-H gel materials obtained from the comparative example 1 and 2 are not shaped.

The shape memory function of the C-S-H gel material obtained in Example 1 was tested. The C-S-H gel material is kneaded and put into deionized water. Within 20 s, the C-S-H gel material that is kneaded and bent can be restored to the shape before it is kneaded and bent. This shows that the self-assembled C-S-H gel produced by the invention has a shape memory function.

The toughness and tensile deformation ability of the C-S-H gel material obtained in Example 1 were tested. As shown in FIG. 4, the tensile test was conducted at 0° C., normal temperature and 100° C. until the fracture, and the maximum tensile length of the material was tested. The results show that at 0° C., the C-S-H gel material can be stretched nearly twice; at room temperature, it can stretch to more than one time; At 100° C., the deformation is very small; This indicates that the performance of the material in Example 1 varies at different temperatures, i.e. it has a temperature sensitive effect. It shows that the self-assembly C-S-H gel produced by the invention has good tensile property and temperature sensitivity.

The invention provides a multifunctional self-assembly C-S-H gel with ultra-high toughness by in-situ polymerization. The self-assembly C-S-H gel has special shape memory function and temperature sensitive effect, and shows ultra-high toughness and excellent tensile deformation ability. During the preparation process, the core material is C-S-H nanoparticles as the dispersed phase, in which acrylic acid, acrylamide reaction monomers and catalysts are added. Then, by adjusting the polymerization conditions and using photoinitiation, the reactive monomers are polymerized on the C-S-H nanoparticles. By in-situ polymerization on C-S-H nanoparticles, a unique core-shell structure C-S-H/organic crosslinked network was constructed. Then, the C-S-H gel with the highly ordered layered structure is formed by the self-assembly of polymer molecules through mutual attraction and aggregation. The present invention not only provides a new idea for the toughening design of cement-based materials in the nano/micro scale, but also provides a very promising application path for the multifunctional application of cement-based materials in the future.

The above descriptions are only preferred embodiments of the present invention and are not intended to limit the present invention. Any modification, equivalent replacement, improvement, etc. made within the spirit and principle of the present invention shall be included in the protection of the present invention.

What is claimed is:

1. An ultra-high-toughness multifunctional self-assembly C-S-H gel material, comprising several stacked core-shell structure layers, wherein the core-shell structural layer is composed of several core-shell structure particles; the core-shell structure particles are composed of calcium silicate hydrate nanoparticles as the core and poly(acrylamide-co-acrylic acid) as the shell.

2. The ultra-high-toughness multifunctional self-assembly C-S-H gel material according to claim 1, wherein the calcium silicate hydrate nanoparticles are needle bar structure.

3. The ultra-high-toughness multifunctional self-assembly C-S-H gel material according to claim 1, wherein the mass of poly(acrylamide-co-acrylic acid) accounts for 10-30% of the total mass of the ultra-high-toughness multifunctional self-assembly C-S-H gel material.

4. A preparation method of the ultra-high-toughness multifunctional self-assembly C-S-H gel material according to claim 1, including the following steps:
S1, obtaining a calcium silicate hydrate suspension;
S2, mixing and stirring acrylic acid, acrylamide, ionic solvent, photoinitiator and crosslinker, and adding them to the calcium silicate hydrate suspension to obtain a C-S-H-AA-AAM slurry;
S3, irradiating the C-S-H-AA-AAM slurry with ultraviolet light to carry out in-situ polymerization and self-assembly reaction, and obtaining the ultra-high-toughness multifunctional self-assembly C-S-H gel material.

5. The preparation method of the ultra-high-toughness multifunctional self-assembly C-S-H gel material according to claim 4, the specific S1 process is as follows: dissolving sodium metasilicate nonahydrate in deionized water to obtain a sodium silicate solution, and dissolving calcium nitrate tetrahydrate in deionized water to obtain a calcium nitrate solution; dropping the calcium nitrate solution into the sodium silicate solution, then stirring to obtain the calcium silicate hydrate suspension.

6. The preparation method of the ultra-high-toughness multifunctional self-assembly C-S-H gel material according to claim 4, wherein the ionic solvent is 1-ethyl-3-methylimidazolium ethyl sulfate; the ratio of the total masses of acrylic acid and acrylamide to the mass of the ionic solvent is 3.3-4:1.

7. The preparation method of the ultra-high-toughness multifunctional self-assembly C-S-H gel material according to claim 4, wherein the photoinitiator is 2-hydroxy-4′-(2-hydroxyethoxy)-2-methylpropiophenone; the ratio of the total masses of acrylic acid and acrylamide to the mass of the photoinitiator is 100:0.5-1.

8. The preparation method of the ultra-high-toughness multifunctional self-assembly C-S-H gel material according to claim 4, wherein the crosslinker is N,N′-methylenebis(acrylamide); the total masses of acrylic acid and acrylamide to the mass of the crosslinker is 100:0.5-1.

9. The preparation method of the ultra-high-toughness multifunctional self-assembly C-S-H gel material according to claim 4, wherein the mass ratio of acrylic acid to acrylamide is 1:4-5.

10. The preparation method of the ultra-high-toughness multifunctional self-assembly C-S-H gel material according to claim 4, the ultra-high-toughness multifunctional self-assembly C-S-H gel material is used for preparing cement-based materials.
